(19) United States
(12) Patent Application Publication
(10) Pub. No.: US 2013/0008591 A1
(43) Pub. Date: Jan. 10, 2013

(54) RESIN FILM COATING METHOD AND COATING DEVICE

(76) Inventor: Kanemitsu Kondo, Anjo-shi (JP)

(21) Appl. No.: 13/635,440

(22) PCT Filed: Mar. 18, 2010
(86) PCT No.: PCT/JP2010/054655

§ 371 Date: Sep. 17, 2012

(51) Int. Cl. B29C 65/02

(52) U.S. Cl. 156/212; 156/475

(57) ABSTRACT

There is provided a coating method that allows a core member surface to be coated with a resin film without causing excess tensile strain on the resin film. A core member 20 on whose surface is formed a protruding part 20A is disposed inside a lower chamber 2b, the protruding part 20A comprising two sloped surfaces 22 and 23, and a ridge line 21. A resin film 10 is so disposed as to partition an internal space of a chamber 2. The resin film 10 is heated in such a manner that a part 23 that is to coat a part on the side where the sloped surface with the smaller slope angle is becomes higher in temperature than a part 22 that is to coat a part on the side where the sloped surface with the greater slope angle is. The resin film 10 is extended in such a manner that the resin film 10 expands towards an upper chamber 2a. The ridge line 21 of the core member 20 is brought into contact with the resin film 10 by moving the core member 20 towards the resin film 10. The resin film 10 is made to conform to the surface shape of the core member 20, thereby coating the core member surface with the resin film 10.

### TECHNICAL FIELD

The present invention relates to a method and device for coating the surface of a core member with a resin film, and, more particularly, to a resin film coating method and a device therefor that are capable of favorably coating a core member, on whose surface is formed a protruding part, with a resin film.

### BACKGROUND ART

There has, in the past, been proposed a coating method in which the surface of a core member made of synthetic resin, metal, etc., is coated (overlaid) with a resin film as a surface material in order to improve the design and corrosion resistance of the core member (see, for example, Patent Literature 1). In this coating method, a core member is disposed in an internal space defined by a pair of chambers, a resin film with which the core member is to be coated is softened by being heated, and the interior of the chambers is pressurized to press the softened resin film onto the core member to coat it.

In addition, with respect to coating the surface of a rectangular cuboid core member (article to be coated) with a resin film (sheet), there has been proposed the following coating method (see, for example, Patent Literature 2). According to this method, first, a core member is disposed within, of a pair of chambers (upper chamber and lower chamber), the lower chamber, and a resin film is disposed between the upper chamber and the lower chamber. Next, the resin film is softened by being heated evenly, and the interior of the lower chamber is made to be of a higher pressure relative to the interior of the upper chamber, causing the resin film to expand towards the upper chamber. The core member is raised towards the expanded resin film, while at the same time the lower chamber is depressurized, thereby coating the upper face and side faces of the core member with the resin film.

Further, with respect to coating a recessed part of a core member having a recessed part with a resin film, the following coating method has been proposed (see, for example, Patent Literature 3). According to this method, a resin film that has been softened by being heated is made to conform to the surface shape of a recessed part by creating a vacuum, and the surface of the recessed part of the core member is thus coated with the resin film.

### Citation List

### Patent Literature

### Patent Literature 1: JP Patent Application Publication (Kokai) No. 2006-007422 A

### Patent Literature 2: JP Patent Application Publication (Kokai) No. 2003-127216 A

### Patent Literature 3: JP Patent Application Publication (Kokai) No. 2001-038797 A

### SUMMARY OF INVENTION

### Technical Problem

However, the coating method disclosed in Patent Literature 1 assumes a case where the shape of the core member is simple and planar, and the coating method disclosed in Patent Literature 2 assumes a simple rectangular cuboid shape with respect to the core member. Accordingly, if there are recesses/protrusions in/on the surface of the core member, particularly if the protruding parts are tall (if the slope angles of the sloped surfaces forming the protruding parts are significant), the methods above would not be able to extend (stretch) the resin film enough due to a lack of pressure, and, in some cases, it may not be possible to place the resin film in tight contact with the core member. As such, in order to make the resin film conform to a core member of such a surface shape, it is preferable that a high pressure be applied to the interior of the chamber, which may, however, cause the resin film to rip.

Further, even with the coating method of Patent Literature 3, at the time of coating, the resin film comes into contact with and is affixed to (restrained by) the perimeter of the opening of the recessed part, after which the part of the resin film that is to coat the recessed part is extended (stretched) by creating a vacuum. Accordingly, a significant tensile strain acts on this part, potentially causing the resin film to rip.

The present invention is made in view of the circumstances above, and an object thereof lies in providing a resin film coating method and coating device that are capable of coating a surface of a core member with a resin film without causing the resin film to rip, even if this surface has recesses/protrusions.

### Solution to Problem

Through diligent consideration with a view to solving the problems above, the inventors have gained new insight that by employing the methods under (1) and (2) below prior to coating, it is possible to favorably coat the surface of a core member with a resin film.

(1) At the time of coating, of the resin film, the resin film portion that is extended less is heated to a higher temperature relative to the resin film portion that is extended (stretched) more.

(2) Pressure is exerted on the resin film in such a manner as not to bring the resin film into contact with the core member, and the resin film portion that is extended less during coating, and which has been heated to a higher temperature, is pre-extended (at this point, the resin film portion that is extended more during coating is not extended much).

The new insight is that by then coating the core member with the resin film that has been partially extended through (1) and (2), since the resin film portion that extends more during coating has some margin (capacity) for extension, the surface of the core member may be coated with the resin film without causing excess tensile strain.

The present invention is made through this new insight, and a resin film coating method according to the present invention is a resin film coating method in which a core member is disposed in an internal space defined by a pair of chambers and a surface of the core member is coated with a resin film, the resin film coating method comprising at least: a step of preparing, as the core member, a core member in which a protruding part is formed on the core member surface, the protruding part comprising at least two sloped surfaces with varying slope angles, and a ridge line formed by the two sloped surfaces; a step of disposing the core member within one chamber of the pair of chambers; a step of disposing the resin film at a position facing the core member surface in such a manner as to partition, between the pair of chambers, the internal space; a step of heating the resin film in such a manner that a second resin film part, which is to coat a part on the side of the ridge line where the sloped surface with the smaller slope angle is, becomes higher in temperature relative to a first resin film part, which is to coat a part on the side of the ridge line where the sloped surface with the greater slope angle is; a step of extending the resin film by making the pressure inside the one chamber be higher relative to the pressure inside other chamber so that the resin film expands towards the other chamber; a step of bringing at least the ridge line of the protruding part of the core member into contact with the resin film by moving the core member towards the extended resin film; and a step of coating the core member surface with the resin film by making the pressure inside the one chamber be lower relative to the pressure inside the other chamber, thereby causing the resin film to conform to the surface shape of the core member.

According to the present invention, in the step of heating the resin film, the second resin film part that coats the part on the side of the ridge line where the sloped surface with the smaller slope angle is is heated to a higher temperature relative to the first resin film part that coats the part on the side of the ridge line where the sloped surface with the greater slope angle is. The second resin film part is thus rendered more readily extendible (stretchable) than the first resin film part.

Next, in the step of extending the resin film, when the resin film is expanded towards the other chamber, the second resin film part extends more than the first resin film part since it is heated to a higher temperature. Accordingly, in this case, the thickness of the second resin film part becomes less than the thickness of the first resin film part.

Since the ridge line is brought into contact with the resin film under these conditions in the step of causing contact with the resin film, the resin film is restrained by the ridge line. In particular, if the back surface of the resin film is coated with a sticky material, e.g., an adhesive, etc., the restraining force with respect to the resin film becomes greater. It thus becomes less likely for the extension of the first resin film part and the extension of the second resin film part to affect each other across the ridge line.

Under these conditions, the interior of the chamber is pressurized to make the resin film conform to the surface shape of the core member, and the surface of the core member is thus coated with the resin film. In so doing, since the extension of the second resin film part in the above-mentioned extension step is less than the extension of the first resin film part, it still has an ample margin (capacity) for extension. Accordingly, even though greater extension is demanded of the surface of the core member on the side of the sloped surface with the greater slope angle as compared to the core member surface on the side of the less sloped surface, it is possible, by virtue of this margin of extension of the first resin film part, to perform extension without causing excessive tensile strain on the first resin film part, and it thus becomes possible to coat the surface of the core member with the resin film.

It is noted that the term “resin film” as used in the context of the present invention is a concept encompassing not only film-shaped resin, but sheet-shaped resin as well. In addition, the expression “extension (stretch) of resin film” refers to such extension where the resin film becomes thinner.

With respect to the protruding part of the core member to be coated, so long as it has two different sloped surfaces, e.g., an undercut shape, a shape having a side surface that extends in a perpendicular direction relative to a flat part of the core member, etc., the shape of the protruding part is not limited in any particular way.

Further, with respect to a resin film coating method according to the present invention, it is preferable that, in the step of preparing the core member, the core member be prepared with a recessed part formed in the core member surface by forming the protruding part at a perimeter part of the core member surface in such a manner that the sloped surface with the greater slope angle is disposed on the inner side, and that the sloped surface with the smaller slope angle is disposed on the outer side, and it is preferable that, in the step of heating the resin film, the resin film be heated in such a manner that a resin film part (the second resin film part) that is to coat a part outside of the ridge line becomes higher in temperature than a resin film part (the first resin film part) that is to coat a part inside of the ridge line.

According to the present invention, in the step of causing contact with the resin film, the resin film comes into contact with at least the ridge line of the protruding part of the core member, and the resin film is restrained by this part. Then, at the time of resin film coating, since the film part (the first resin film part) that is to coat the part inside of the ridge line has a margin for extension, it is possible to extend the resin film with ease towards the recessed part inside of the ridge line. It is thus possible to coat the surface of the core member with the resin film without causing excess tensile strain on the resin film.

Further, so long as the degrees of extension of the resin film may be differentiated in the step of heating the resin film, the heating temperatures for the resin film are not limited in any particular way. However, in the step of heating the resin film, it is preferable that the second resin film part be heated to a temperature equal to or above the softening temperature (glass transition temperature) of the resin in the resin film, and that the first resin film part be heated below the softening temperature. The extension of the second resin film part in the extension step may thus be made greater, thereby giving the first resin film part a greater margin for extension.

In addition, with respect to a resin film coating method according to the present invention, while the step of heating the resin film and the step of extending the resin film may be performed in sequence, it is preferable that the step of heating the resin film and the step of extending the resin film be performed simultaneously. By performing these steps simultaneously, it is possible to shorten the duration of the coating process.

In addition, in the resin film coating step, it is preferable that the interior of the one chamber be depressurized, while also pressurizing the interior of the other chamber. With the present invention, by depressurizing the chamber in which the core member is disposed, it is possible to favorably evacuate the air between the core member and the resin film.

In the present application, there is also disclosed a coating device for favorably performing the coating method above. A coating device according to the present invention is a resin film coating device which coats, with a resin film, a surface of a core member on whose surface is formed a protruding part including at least two sloped surfaces with varying slope angles and a ridge line formed by the two sloped surfaces, the coating device comprising at least: a pair of chambers in which an internal space for disposing the core member in is defined; in one chamber of the pair of chambers, a stage on which the core member is to be placed; a film setting part for setting the resin film at a position facing the stage in such a manner as to partition, between the pair of chambers, the internal space; a heating part comprising, inside other chamber, a first heating part, which heats a first resin film part that is to coat a part on the side of the ridge line where the sloped surface with the greater slope angle is, and a second heating part, which heats a second resin film part that is to coat a part on the side of the ridge line where the sloped surface with the smaller slope angle is, the second heating part generating heat at a higher temperature than the first heating part; a pressure adjusting part that adjusts a pressure inside the pair of chambers in such a manner that a relative pressure difference is generated between the pressure inside the one chamber and the pressure inside the other chamber; and a stage moving part that moves the stage towards the other chamber

With the present invention, since the second heating part generates heat at a higher temperature than the first heating part, it is possible to heat the second resin film part, which coats the part on the side of the ridge line where the sloped surface with the smaller slope angle is, to a higher temperature relative to the first resin film part, which coats the part on the side of the ridge line where the sloped surface with the greater slope angle is. Thus, by making the pressure inside the one chamber be higher relative to the pressure inside the other chamber by means of the pressure adjusting part, it is possible to extend the second resin film part more than the first resin film part. Further, at the time of coating, it is possible to bring the ridge line into contact with the resin film by means of the stage moving part. By thereafter making the pressure inside the one chamber be lower relative to the pressure inside the other chamber by means of the pressure adjusting part, it is possible to coat the surface of the core member with the resin film by extending the first resin film part which has been given a margin of extension.

Further, it is preferable that a coating device according to the present invention be a device for coating, with the resin film and as the core member, a core member in which a recessed part is formed in the core member surface by forming the protruding part at a perimeter part of the core member surface in such a manner that the sloped surface with the greater slope angle is disposed on the inner side, and that the sloped surface with the smaller slope angle is disposed on the outer side, and it is preferable that the first heating part be so disposed as to heat a resin film part (the first resin film part) that is to coat a part inside of the ridge line, and the second heating part be so disposed as to heat a resin film part (the second resin film part) that is to coat a part outside of the ridge line.

With the present invention, by heating the resin film part (the second resin film part) that coats a part outside of the ridge line to a higher temperature than the resin film part (the first resin film part) that coats the part inside of the ridge line, it is possible to extend the second resin film part by means of the pressure adjusting part. Since this provides for a margin of extension at the time of coating for the first resin film part, it is possible to coat the sloped surface with the greater slope angle with the film without causing the resin film to rip.

### Advantageous Effects of Invention

With the present invention, it is possible to coat the surface of a core member with a resin film without causing excess tensile strain on the resin film even if the surface of the core member is a surface with protrusions and recesses.

### BRIEF DESCRIPTION OF DRAWINGS

FIG. 1 is a schematic sectional view illustrating a step of positioning a core member and a resin film with respect to a resin film coating method according to the first embodiment of the present invention.

FIG. 2 is a schematic perspective view illustrating a positional state of heating parts, a resin film, and a core member in a step of heating the resin film with respect to a resin film coating method according to the first embodiment of the present invention.

FIG. 3 is a schematic sectional view illustrating a step of extending a resin film with respect to a resin film coating method according to the first embodiment of the present invention.

FIG. 4 is a schematic sectional view illustrating a step of bringing a core member into contact with a resin film with respect to a resin film coating method according to the first embodiment of the present invention.

FIG. 5 is a schematic sectional view illustrating a step of coating the surface of a core member with a resin film with respect to a resin film coating method according to the first embodiment of the present invention.

FIG. 6 is a schematic sectional view illustrating a step of positioning a core member and a resin film with respect to a resin film coating method according to the second embodiment of the present invention.

FIG. 7 is a schematic perspective view illustrating a positional state of heating parts, a resin film, and a core member in a step of heating the resin film with respect to a resin film coating method according to the second embodiment of the present invention.

FIG. 8 is a schematic sectional view illustrating a step of extending a resin film with respect to a resin film coating method according to the second embodiment of the present invention.

FIG. 9 is a schematic sectional view illustrating a step of bringing a core member into contact with a resin film with respect to a resin film coating method according to the second embodiment of the present invention.

FIG. 10 is a schematic sectional view illustrating a step of coating the surface of a core member with a resin film with respect to a resin film coating method according to the second embodiment of the present invention.

### DESCRIPTION OF EMBODIMENTS

The present invention is described below based on two embodiments with reference to the drawings.

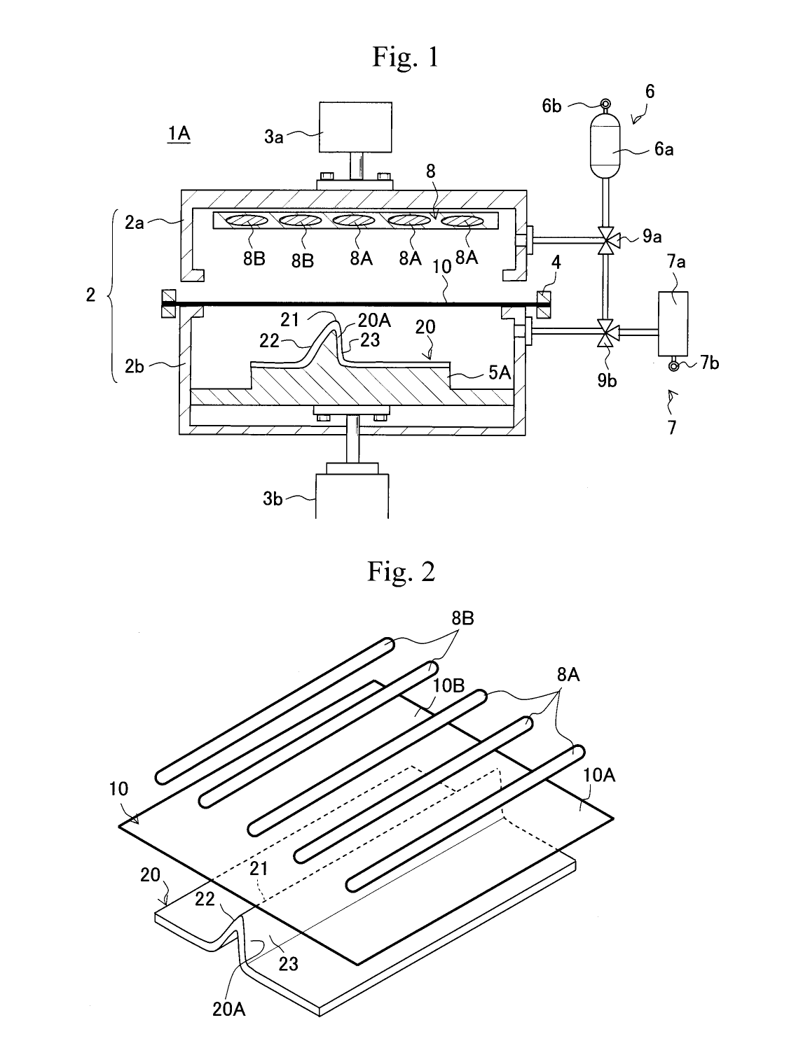

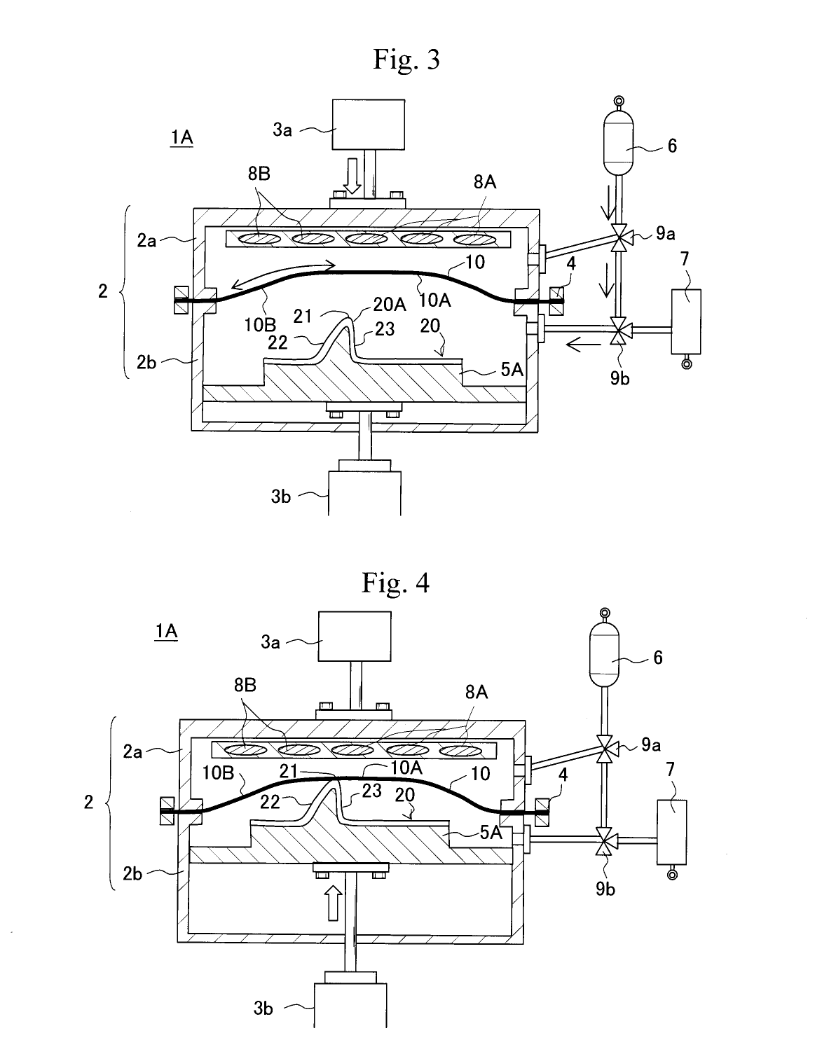

FIG. 1 is a schematic sectional view illustrating a step of positioning a core member and a resin film with respect to a coating method according to the first embodiment of the present invention. It also shows a coating device for favorably performing coating with a resin film with respect to the first embodiment. FIG. 2 is a schematic perspective view illustrating a positional state of heating parts, a resin film, and a core member in a step of heating the resin film with respect to a resin film coating method according to the first embodiment of the present invention. FIG. 3 is a schematic sectional view illustrating a step of extending a resin film with respect to a resin film coating method according to the first embodiment of the present invention.

As shown in FIG. 1, a coating device 1A comprises a chamber pair 2 comprising an upper chamber 2a (the other chamber) and a lower chamber (the one chamber) 2b. An upper chamber moving device 3a for moving the upper chamber 2a in the up/down direction is connected to the upper chamber 2a. As the upper chamber 2a is lowered towards the lower chamber 2b by driving the upper chamber moving device 3a, a sealed internal space in which a core member 20 is to be disposed is formed inside the chamber pair 2 as shown in FIG. 3.

The lower chamber 2b is fixed, and thereinside is disposed a stage 5A on which the core member 20 is to be mounted. The mounting surface of the stage 5A is of a surface shape that matches the shape of the core member 20 so as to allow the core member 20 to be mounted in a stable manner. A stage moving device (stage moving part) 3b for moving the stage 5A by raising/lowering it in the up/down direction within the chamber 2 is linked to the stage 5A.

In addition, the coating device 1 A further comprises a film setting part 4 for setting a resin film 10, and heating parts 8 that heat the resin film 10. The film setting part 4 is adapted to set the resin film 10 at a position facing the stage 5A (a position that covers the opening of the lower chamber 2b) between the upper chamber 2a and the lower chamber 2b. As shown in FIG. 3, the resin film 10 is thus able to partition the internal space within the chamber 2.

In the present case, as shown in FIG. 2, the core member 20 to be coated with the resin film 10 is made of metal, and a protruding part 20A is formed on the surface of that core member. This protruding part 20A comprises at least two sloped surfaces 22 and 23 of varying slope angles, and a ridge line 21 formed by these two sloped surfaces 22 and 23. Further, of the two sloped surfaces 22 and 23, at least one, namely the sloped surface 23, has a greater slope angle relative to the other, namely the sloped surface 22. The term slope angle as used above refers to the angle formed by a flat surface of the core member 20 other than the protruding part 20A (a surface that is generally parallel to the surface (or the rear surface) of the resin film) and the sloped surface. Accordingly, the sloped surface 23 with the greater slope angle is steeper than the sloped surface 22 with the smaller slope angle.

The present embodiment coats such a core member 20 with the resin film 10, and the device configuration of the heating parts 8 differs significantly from conventional ones. Specifically, they are adapted to differentiate heating temperatures across the ridge line 21 between a part (first resin film part) 10A of the resin film 10 that coats the part on the side of the sloped surface 23 with the greater slope angle and a part (second resin film part) 10B of the resin film 10 that coats the part on the side of the sloped surface 22 with the smaller slope angle.

Specifically, the heating parts 8 are disposed within the upper chamber 2a, and comprise first heating parts 8A and second heating parts 8B. The second heating parts 8B are adapted to generate heat at a higher temperature relative to the first heating parts 8A. In addition, as shown in FIG. 2, the first heating parts 8A are so positioned as to heat the part (first resin film part) 10A of the resin film 10 that coats the part on the side of the ridge line 21 where the sloped surface 23 with the greater slope angle is. The second heating parts 8B are so positioned as to heat the part (second resin film part) 10B of the resin film 10 that coats the part on the side of the ridge line 21 where the sloped surface 22 with the smaller slope angle is.

Accordingly, when heating the resin film 10, the heating parts 8 are able to heat the second resin film part 10B to a higher temperature relative to the first resin film part 10A. It is noted that, when extending (expanding) the resin film 10, the resin film 10 is placed in close proximity to the heating parts 8, and some change in the heating condition for the resin film 10 mentioned above may consequently occur. In this case, it is preferable that the steps from the step of extending the resin film 10 to the step of bringing the core member 20 into contact with the resin film 10 (see FIG. 4 discussed below) be performed quickly. However, if it is desired that a softened state of the resin film be ensured in a more stable manner, it is preferable that the heating parts 8 be such that the heat generation amounts (heating temperatures) of the first heating parts 8A and second heating parts 8B are so configured that, even in a state where the resin film 10 is expanded (extended) as shown in FIG. 3, the second resin film part 10B would be heated to a higher temperature relative to the first resin film part 10A. In this case, as discussed later, the heating and extending of the resin film 10 may be performed simultaneously.

Here, with respect to the heating parts 8, so long as they are able to heat the resin film 10, their heating method is not limited in any particular way. By way of example, in the case of an electric heater, the configuration is such that the current passed through the heating wires of the second heating parts is greater relative to that of the first heating parts. In addition, examples of the upper chamber moving device 3a and the stage moving device 3b may include a mechanism comprising a cylinder and a piston, a mechanism that converts rotary motion into linear motion, etc. So long as they are able to move the upper chamber 2a and the stage 5A in the up/down direction, their mechanisms are not limited in any particular way.

The coating device 1A further comprises a compressed air device 6 that is able to pressurize the interior of the chamber to or above atmospheric pressure, and a vacuum device 7 that is able to bring the interior of the chamber to a negative pressure of or below atmospheric pressure. They are in communication with the upper and lower chambers 2a and 2b via three-way valves 9a and 9b. The devices 6 and 7 are respectively provided with accumulator tanks 6a and 7a for supplying pressure stably. The compressed air device 6 has a compressor 6b connected to the tank 6a. The vacuum device 7 has a vacuum pump 7b connected to the tank 7a. It is noted that, in the present embodiment, these devices 6, 7, 9a, and 9b correspond to a pressure adjusting part in the context of the present invention. However, this device configuration is by no means limiting, and so long as both of the following pressure adjustments are enabled, the configuration may comprise the compressed air device 6 only, or the vacuum device 7 only: (1) making the pressure inside the upper chamber 2a be higher relative to the pressure inside the lower chamber 2b, and (2) making the pressure inside the upper chamber 2a be lower relative to the pressure inside the lower chamber 2b.

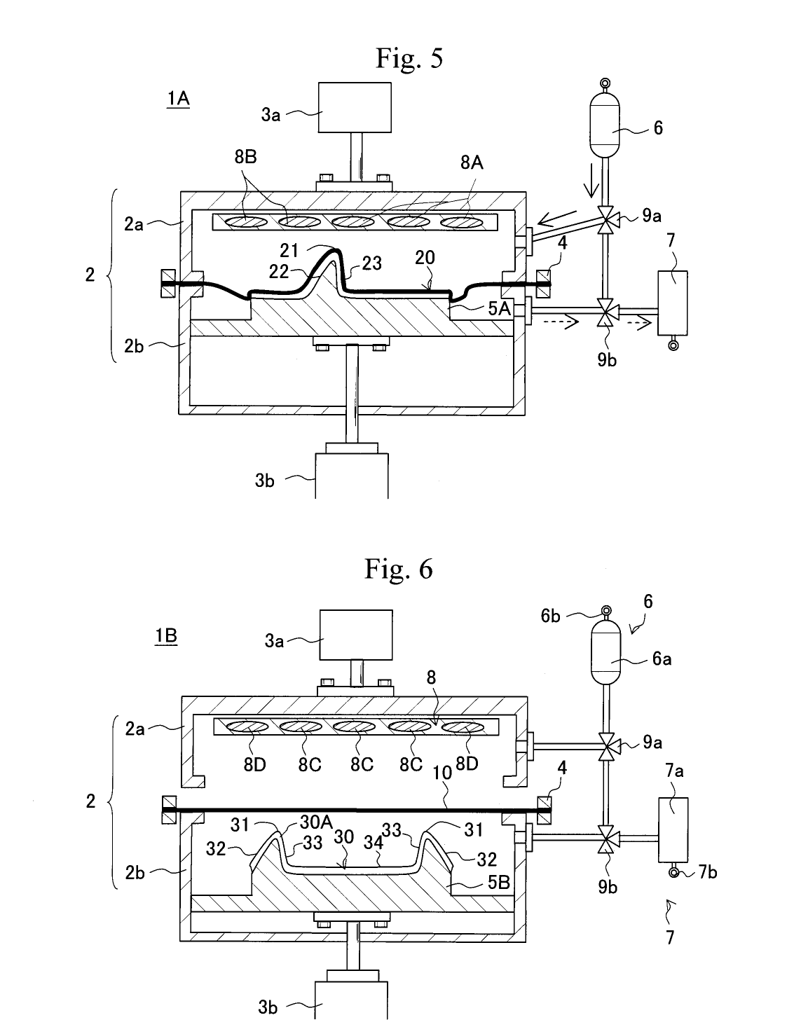

A coating method for the resin film 10 using the coating device 1A thus configured is described below with reference to FIGS. 4 and 5 in addition to FIGS. 1 to 3. FIG. 4 is a schematic sectional view illustrating a step of bringing a core member into contact with a resin film with respect to a resin film coating method according to the first embodiment of the present invention. FIG. 5 is a schematic sectional view illustrating a step of coating the surface of a core member with a resin film with respect to a resin film coating method according to the first embodiment of the present invention.

First, the above-mentioned core member 20 is prepared, and the core member 20 is placed on the stage 5A within the lower chamber 2b of the chamber pair 2 as shown in FIG. 1. Next, using the film setting part 4, the resin film 10 is disposed at a position facing the surface of the core member in such a manner as to partition, between the upper chamber 2a and the lower chamber 2b, the internal space. It is noted that the back surface of the resin film 10 (the surface that comes into contact with the core member 20) is coated with an adhesive as a sticking agent. It is thus possible to, at the time of coating discussed later (see FIG. 5), cause the resin film 10 to adhere to the surface of the core member 20.

Then, with the above thus disposed, the upper chamber moving device 3a is actuated to move the upper chamber 2a towards the lower chamber 2b (see FIG. 3). Independent closed spaces are thus formed as internal spaces respectively in the upper and lower chambers 2a and 2b by the resin film 10. It is noted that the three-way valves 9a and 9b are in a closed state so as to prevent the pressure within the chamber 2 from varying.

Next, the resin film 10 is heated using the heating parts 8 disposed in the upper chamber 2a. Specifically, as shown in FIG. 2, the part (first resin film part) 10A of the resin film that coats the part on the side of the ridge line 21 where the sloped surface 23 with the greater slope angle is is heated with the first heating parts 8A, and the part (second resin film part) 10B of the resin film that coats the part on the side of the ridge line 21 where the sloped surface 22 with the smaller slope angle is is heated with the second heating parts 8B. The second heating parts 8B generate heat at a higher temperature (generate more heat) relative to the first heating parts 8A. The second resin film part 10B is thus heated to a higher temperature relative to the first resin film part 10A.

Further, the three-way valves 9a and 9b are manipulated as shown in FIG. 3 to supply compressed air into the lower chamber 2b from the compressed air device 6. The pressure inside the lower chamber 2b thus becomes higher relative to the pressure inside the upper chamber 2a. It is consequently possible to extend (stretch) the resin film 10 in such a manner that it expands towards the upper chamber.

Since, at this point, the second resin film part 10B is heated to a higher temperature relative to the first resin film part 10A, the second resin film part 10B is extended more than the first resin film part 10A (see the solid line arrow in FIG. 3). In other words, the thickness of the first resin film part 10A is now greater relative to that of the second resin film part 10B, consequently giving the first resin film part 10A a margin of extension for the later coating step (see FIG. 5).

Here, by heating the second resin film part 10B to a temperature equal to or above the softening temperature, and the first resin film part 10A to a temperature below the softening temperature, it is possible to cause greater extension of the second resin film part 10B in a more favorable manner.

It is noted that, in order to clearly describe each step, the step of heating the resin film 10, and the step of extending the heated resin film in such a manner that it expands towards the upper chamber 2a were performed separately and consecutively. However, so long as the second resin film part 10B, in the expanded state, is heated to a relatively higher temperature, that is, so long as the second resin film part 10B, in the expanded state, is extended relative to the first resin film part 10A, these two steps may of course be performed simultaneously.

Next, the stage 5A is raised using the stage moving device 3b as shown in FIG. 4. The core member 20 thus moves towards the expanded resin film 10. The back surface of the resin film 10 is then brought into contact with at least the ridge line 21 of the protruding part 20A of the core member 20. The resin film 10 is consequently restrained by the ridge line 21. It thus becomes less likely for the extension of the first resin film part 10A and the extension of the second resin film part 10B to affect each other across the ridge line 21. It is noted that since, in the present embodiment, an adhesive is applied to the back surface of the resin film 10, the restraining force of the ridge line 21 is made greater.

Next, the resin film 10 in the expanded state is deformed in such a manner that it coats, and adheres to, the surface of the core member 20. Specifically, as shown in FIG. 5, the pressure inside the lower chamber 2b is made to be lower relative to the pressure inside the upper chamber 2a, thereby causing the resin film 10 to conform to the surface shape of the core member 20, and coating the core member surface with the resin film 10.

In the present embodiment, the three-way valves 9a and 9b are manipulated to supply compressed air from the compressed air device 6 to the upper chamber 2a, thereby creating a pressurized state where the pressure is higher than atmospheric pressure (see the solid line arrows in FIG. 5). On the other hand, the vacuum device 7 is activated to suck out the air inside the lower chamber 2b, thereby creating a depressurized state in the lower chamber 2b where the pressure is lower than atmospheric pressure (see the dashed line arrows in FIG. 5). It is thus made less likely for air to be trapped between the core member 20 and the resin film 10. However, this method is not limiting, and, instead, just the upper chamber 2a may be placed in a pressurized state, or just the lower chamber 2b may be placed in a depressurized state.

Since the sloped surface 22 has a moderate slope, with respect to the core member surface on the side of the sloped surface 22 with the smaller slope angle, the second resin film part 10B need not be extended more relative to the first resin film part 10A at the time of coating. Accordingly, even if the core member surface on the side of the sloped surface 22 with the smaller slope angle is coated with the already extended resin film part 10B, there is no need for excess tensile strain to act on this film part.

On the other hand, since the sloped surface 23 is steep, with respect to the core member surface on the side of the sloped surface 23 with the greater slope angle, the first resin film part 10A needs to be extended more relative to the second resin film part 10B at the time of coating. Accordingly, since the first resin film part 10A has a greater margin for extension relative to the second resin film part 10B, even if the first resin film part 10A is extended more, the first resin film part 10A may be extended without causing excess tensile strain.

The surface of the core member 20 may thus be coated with the resin film 10 with an adhesive in-between, and without causing excess tensile strain on the surface of the core member 20, that is, without causing the resin film to become thin locally. The interior of the chamber 2 is then adjusted to atmospheric pressure, the upper chamber 2a is opened, and the core member 20 coated with the resin film 10 is taken out.

In the present embodiment, a core member comprising a metal material was used for the core member. Examples of such a metal may include steel, cast iron, an aluminum alloy, a titanium alloy, etc. Further, so long as no deformation, etc., is caused by the heat from the heating parts, and so long as a protruding part may be formed, its material is by no means limited to metal materials, and may instead be, for example, a polymeric resin, e.g., thermosetting resin, etc.

In addition, a thickness of roughly 0.1 mm to 1 mm is preferable for the resin film, and so long as it is extendible, its material is not limited in any particular way. Taking ease of extension by the heat of the heating parts into account, thermoplastic resins such as resins of, for example, PP, PA, PET, etc., are preferable.

The second embodiment according to the present invention is described below with reference to FIGS. 6 to 10. In the second embodiment, the shape of the core member (and the shape of the stage on which it is mounted), and the configuration of the heating parts that heat the resin film differ from those of the first embodiment. As such, only these differences are described in detail, and members and devices with like functions to those of the first embodiment are designated with like reference numerals while omitting detailed descriptions thereof.

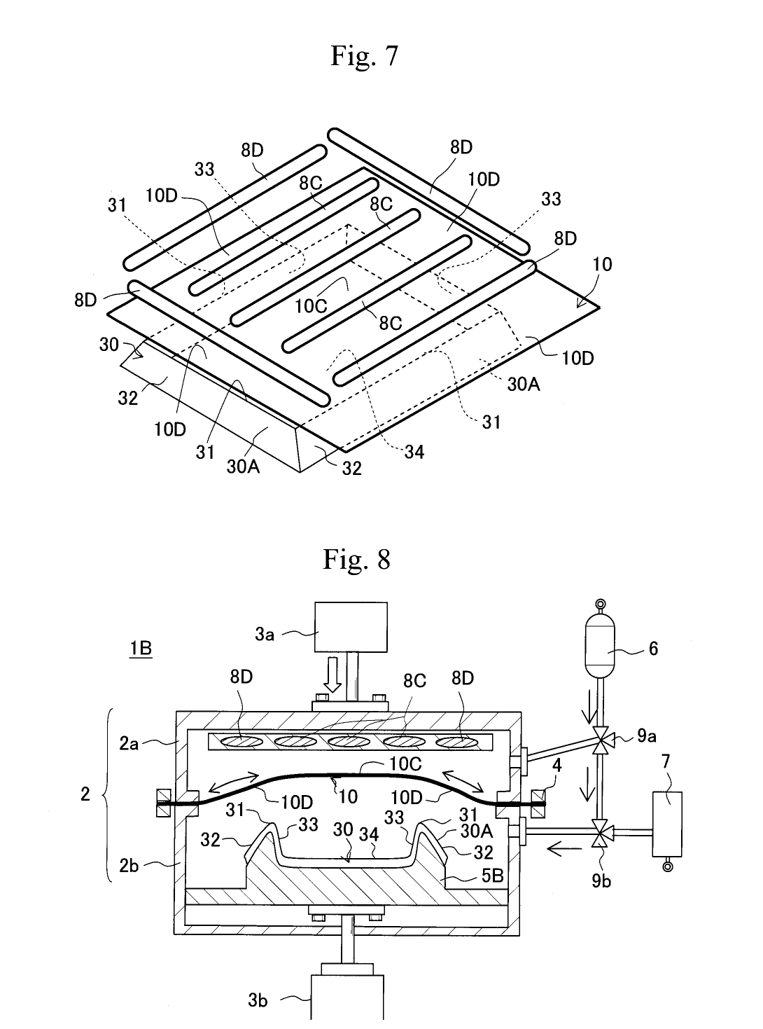

FIG. 6 is a schematic sectional view illustrating a step of positioning a core member and a resin film with respect to a resin film coating method according to the second embodiment of the present invention. FIG. 7 is a schematic perspective view illustrating a positional state of heating parts, a resin film, and a core member in a step of heating the resin film with respect to a resin film coating method according to the second embodiment of the present invention. In addition, FIG. 8 is a schematic sectional view illustrating a step of extending a resin film with respect to a resin film coating method according to the second embodiment of the present invention.

The surface of a core member 30 is coated with the resin film 10 using a coating device 1B. As shown in FIGS. 6 and 7, the core member 30 has a protruding part 30A formed at the perimeter part of the core member surface. As in the first embodiment, the protruding part 30A comprises a sloped surface 32 with a smaller slope angle, a sloped surface 33 with a greater slope angle, and a ridge line 31 formed by these sloped surfaces 32 and 33.

Specifically, the protruding part 30A is so formed that the sloped surface 33 with the greater slope angle is located on the inner side (facing the center of the core member surface), and that the sloped surface 32 with the smaller slope angle is located on the outer side (facing away from the core member surface). Further, the ridge line 31 with four sides is formed at the apex of the protruding part 30A by these sloped surfaces 32 and 33. By thus forming the continuous protruding part 30A at the perimeter part of the core member surface, a recessed part 34 is formed in the core member surface.

As shown in FIG. 8, first heating parts 8C are so disposed as to heat the resin film that coats the part on the side of the sloped surface 33 with the greater slope angle, that is, a resin film part (first resin film part) 10C that coats the part inside of the ridge line 31. In addition, second heating parts 8D are so disposed as to heat the resin film that coats the part on the side of the sloped surface 32 with the smaller slope angle, that is, a resin film part (second resin film part) 10D that coats the part outside of the ridge line 21. In addition, as in the first embodiment, the second heating parts 8D generate heat at a higher temperature than the first heating parts 8C.

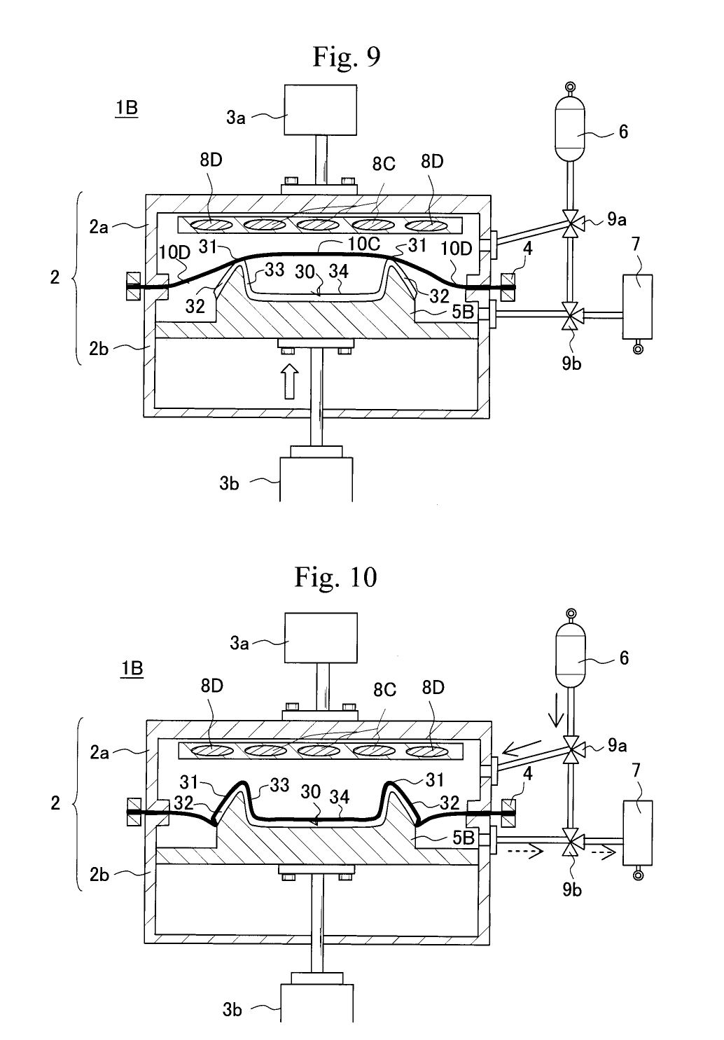

With further reference to FIGS. 9 and 10 below in addition to FIGS. 6 to 8, the core member 30 is coated with the resin film 10 using the thus configured coating device 1B. FIG. 9 is a schematic sectional view illustrating a step of bringing a core member into contact with a resin film with respect to a resin film coating method according to the second embodiment of the present invention. FIG. 10 is a schematic sectional view illustrating a step of coating the surface of a core member with a resin film with respect to a resin film coating method according to the second embodiment of the present invention.

First, the core member 30 is prepared, and the core member 30 is placed on a stage 5B within the lower chamber 2b of the chamber pair 2 as shown in FIG. 6. Using the film setting part 4, the resin film 10 is disposed at a position facing the surface of the core member in such a manner as to partition, between the chamber pair 2, the internal space. The upper chamber 2a is moved towards the lower chamber 2b. It is noted that the back surface of the resin film is coated with an adhesive.

As shown in FIG. 7, the first resin film part 10C is heated with the first heating parts 8C, and the second resin film part 10D is heated with the second heating parts 8D. The second resin film part 10D is thus heated to a high temperature relative to the first resin film part 10C.

The three-way valves 9a and 9b are manipulated as shown in FIG. 8, thereby making the pressure inside the lower chamber 2b be higher relative to the pressure inside the upper chamber 2a by means of the compressed air device 6. Since, at this point, the second resin film part 10D is heated to a higher temperature relative to the first resin film part 10C, the resin film part 10D that coats the part on the side of the sloped surface 32 with the smaller slope angle is extended more than the first resin film part 10C (see the solid line arrows in FIG. 8). As was noted in connection with the first embodiment, the heating step and the extending step may also be performed simultaneously.

Next, as shown in FIG. 9, the stage 5B is raised, and the resin film 10 is brought into contact with the ridge line 31 of the protruding part 30A of the core member 30. The resin film 10 is consequently restrained by the ridge line 31. It thus becomes less likely for the extension of the first resin film part 10C and the extension of the second resin film part 10D to affect each other across the ridge line 31.

Next, as shown in FIG. 10, the pressure inside the lower chamber 2b is made to be lower relative to the pressure inside the upper chamber 2a (see the solid line arrows and dashed line arrows in FIG. 10), thereby causing the resin film 10 to conform to the surface shape of the core member 30, and coating the core member surface with the resin film 10.

Since the sloped surface 32 has a moderate slope, with respect to the core member surface on the side of the sloped surface 32 with the smaller slope angle, the second resin film part 10D need not be extended more relative to the first resin film part 10C at the time of coating. Accordingly, even if the core member surface on the side of the sloped surface 32 with the smaller slope angle is coated with the already extended resin film part 10D, there is no need for excess tensile strain to act on this film part.

On the other hand, since the sloped surface 33 is steep, with respect to the core member surface on the side of the sloped surface 33 with the greater slope angle, that is, with respect to the surface of the recessed part 34, the first resin film part 10C needs to be extended more relative to the second resin film part 10D at the time of coating. Accordingly, since the first resin film part 10C has a greater margin for extension relative to the second resin film part 10D, even if the first resin film part 10C is extended more, the first resin film part 10C may be extended without causing excess tensile strain. It is possible to coat with ease the recessed part 34 located inside of the ridge line 31 with the first resin film part 10C.

Embodiments of the present invention have been described in detail above. However, the present invention is by no means limited to the embodiments above, and various design modifications may be made within a scope that does not depart from the spirit of the present invention as provided in the claims.

By way of example, in the present embodiments, rectangular core members were coated with a resin film. However, so long as there is a protruding part on the surface, the external shape of the core member is by no means limited to the above, and the core member may instead be, for example, disc-shaped, or rhombus-shaped.

### REFERENCE SIGNS LIST

1A, 1B: coating device, 2: chamber, 2a: upper chamber (other chamber), 2b: lower chamber (one chamber), 3a: upper chamber moving device, 3b: stage moving device (stage moving part), 4: film setting part, 5A, 5B: stage, 6: compressed air device, 7: vacuum device, 8: heating part, 8A, 8C: first heating part, 8B, 8D: second heating part, 9a, 9b: three-way valve, 10: resin film, 10A, 10C: first resin film part, 10B, 10D: second resin film part, 20, 30: core member, 20A, 30A: protruding part, 21, 31: ridge line, 22, 32: sloped surface with smaller slope angle, 23, 33: sloped surface with greater slope angle, 34: recessed part

1. A resin film coating method in which a core member is disposed in an internal space defined by a pair of chambers and a surface of the core member is coated with a resin film, the resin film coating method comprising at least:
a step of preparing, as the core member, a core member in which a protruding part is formed on the core member surface, the protruding part comprising at least two sloped surfaces with varying slope angles, and a ridge line formed by the two sloped surfaces;
a step of disposing the core member within one chamber of the pair of chambers;
a step of disposing the resin film at a position facing the core member surface in such a manner as to partition, between the pair of chambers, the internal space;
a step of heating the resin film in such a manner that a second resin film part, which is to coat a part on the side of the ridge line where the sloped surface with the smaller slope angle is, becomes higher in temperature relative to a first resin film part, which is to coat a part on the side of the ridge line where the sloped surface with the greater slope angle is;
a step of extending the resin film by making the pressure inside the one chamber be higher relative to the pressure inside other chamber so that the resin film expands towards the other chamber;
a step of bringing at least the ridge line of the protruding part of the core member into contact with the resin film by moving the core member towards the extended resin film; and
a step of coating the core member surface with the resin film by making the pressure inside the one chamber be lower relative to the pressure inside the other chamber, thereby causing the resin film to conform to the surface shape of the core member.

2. The resin film coating method according to claim 1, wherein in the step of preparing the core member, the core member is prepared with a recessed part formed in the core member surface by forming the protruding part at a perimeter part of the core member surface in such a manner that the sloped surface with the greater slope angle is disposed on the inner side, and that the sloped surface with the smaller slope angle is disposed on the outer side, and
in the step of heating the resin film, the resin film is heated in such a manner that a resin film part that is to coat a part outside of the ridge line becomes higher in temperature than a resin film part that is to coat a part inside of the ridge line.

3. The resin film coating method according to claim 1, wherein, in the step of heating the resin film, the second resin film part is heated to a temperature equal to or greater than a resin softening temperature of the resin film.

4. The resin film coating method according to claim 1, wherein the step of heating the resin film and the step of extending the resin film are performed simultaneously.

5. A resin film coating device which coats, with a resin film, a surface of a core member on whose surface is formed a protruding part including at least two sloped surfaces with varying slope angles and a ridge line formed by the two sloped surfaces, the coating device comprising at least:
a pair of chambers in which an internal space for disposing the core member in is defined;
in one chamber of the pair of chambers, a stage on which the core member is to be placed;
a film setting part for setting the resin film at a position facing the stage in such a manner as to partition, between the pair of chambers, the internal space;
a heating part comprising, inside other chamber, a first heating part, which heats a first resin film part that is to coat a part on the side of the ridge line where the sloped surface with the greater slope angle is, and a second heating part, which heats a second resin film part that is to coat a part on the side of the ridge line where the sloped surface with the smaller slope angle is, the second heating part generating heat at a higher temperature than the first heating part;
a pressure adjusting part that adjusts a pressure inside the pair of chambers in such a manner that a relative pressure difference is generated between the pressure inside the one chamber and the pressure inside the other chamber; and
a stage moving part that moves the stage towards the other chamber.

6. The resin film coating device according to claim 5, wherein
the coating device is a device for coating, with the resin film and as the core member, a core member in which a recessed part is formed in the core member surface by forming the protruding part at a perimeter part of the core member surface in such a manner that the sloped surface with the greater slope angle is disposed on the inner side, and that the sloped surface with the smaller slope angle is disposed on the outer side, and
the first heating part is so disposed as to heat a resin film part that is to coat a part inside of the ridge line, and the second heating part is so disposed as to heat a resin film part that is to coat a part outside of the ridge line.
